(19) United States
(12) Patent Application Publication
(10) Pub. No.: US 2012/0264087 A1
(43) Pub. Date: Oct. 18, 2012

(54) Designers' runway fashion party

(76) Inventor: Catherine Hebert, (US)

(21) Appl. No.: 12/930,438

(22) Filed: Apr. 18, 2011

(51) Int. Cl. G09B 11/00

(52) U.S. Cl. 434/81

(57) ABSTRACT

Designer's Runway Fashion Party kit is a fun party kit that relates to young girls. It is a kit for designing a skirt. The girls are provided with a party kit. The kit is designed so that each girl has full credit for her creation. She also gets to model her creation and talk about her creation on a make believe runway.

The kit has a newspaper page, some fabric, glue and string. The girl cuts the fabric using the newspaper pattern. She glues the skirts sides and hems (top and bottom) the skirt. She inserts string or ribbon through top hem making the waist. The string is drawn to draw the waist together. The invention is for fun and to assist the creativity of the children in designing their own fashion. After the fabric is made into a skirt, the girl decorates it. She may use markers, sequins, applicades, ribbon or anything she likes.

The girl then becomes a model. She can write a script, or a script can be provided for her. She can pretend to market her skirt as she models.

### BACKGROUND OF THE INVENTION

I know that this kit is related to other kits for making for making clothing.

This is a variation in the use of patterns and fabric in that this just belongs to the children who design their own fashion, walk a runway, model and describe their fashion.

Summary of invention is to provide a young girl with a designer's skirt kit. The girls make a skirt, decorate it and walk the runway with a scripted message.

Summary of invention is to provide a young girl with a designer's skirt kit. The girls make a skirt, decorate it and walk the runway with a scripted message.

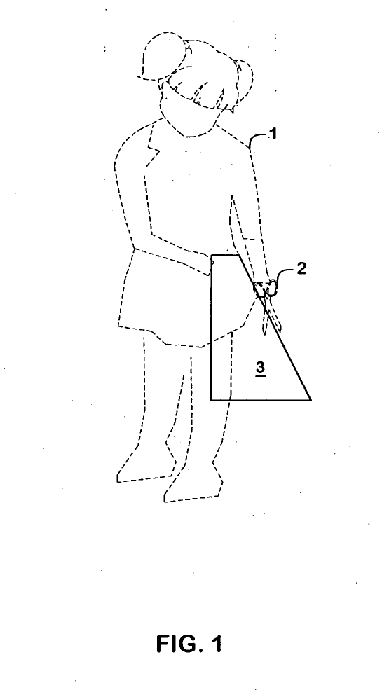

FIG. 1 is a front view of step 1 to cut the pattern

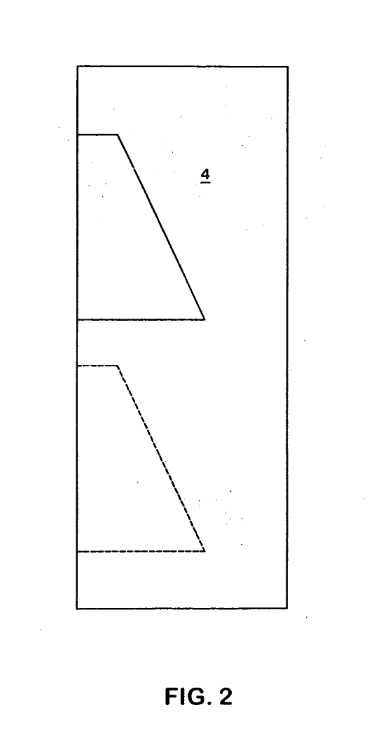

FIG. 2 is the pattern fitted on the piece of fabric which is in step 2

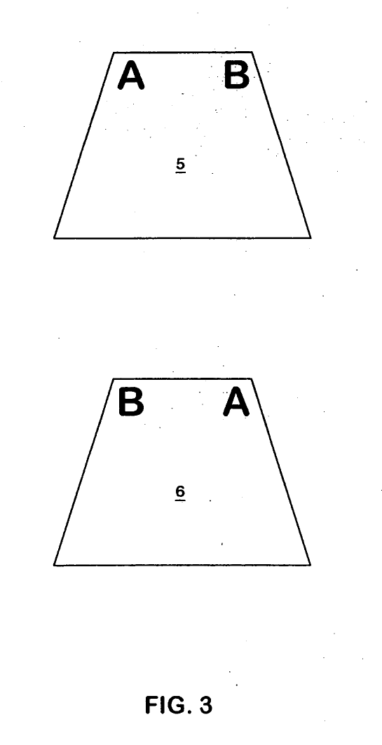

FIG. 3 is a back and front of the skirt labeled AB and BA to show how the skirt is glued together in step 3

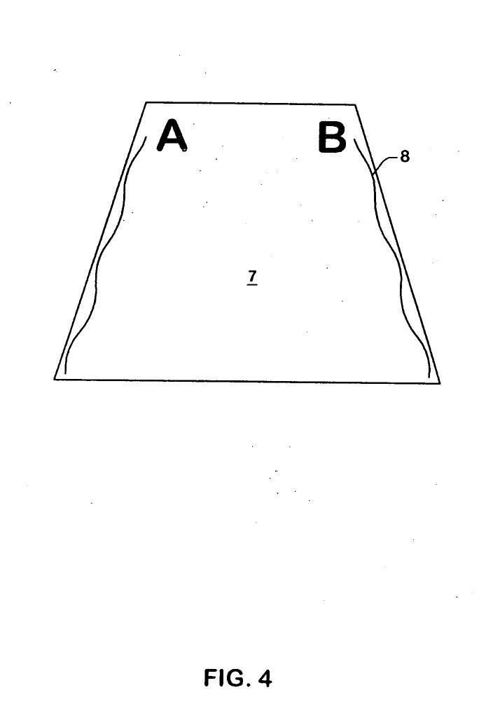

FIG. 4 shows how the skirt is glued in step 4

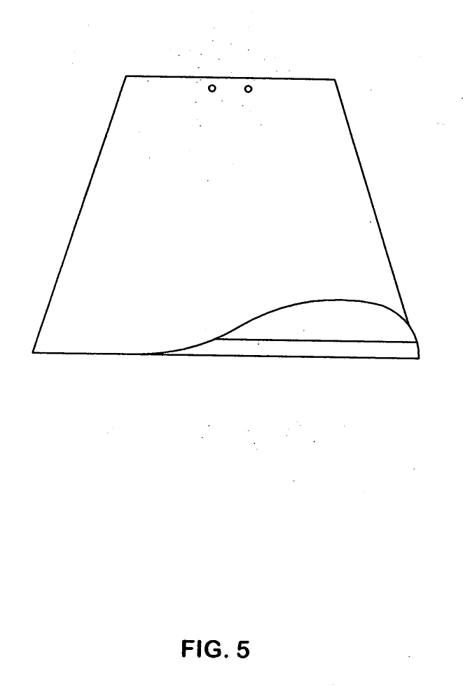

FIG. 5 shows the view of the skirt turn right side in step 5

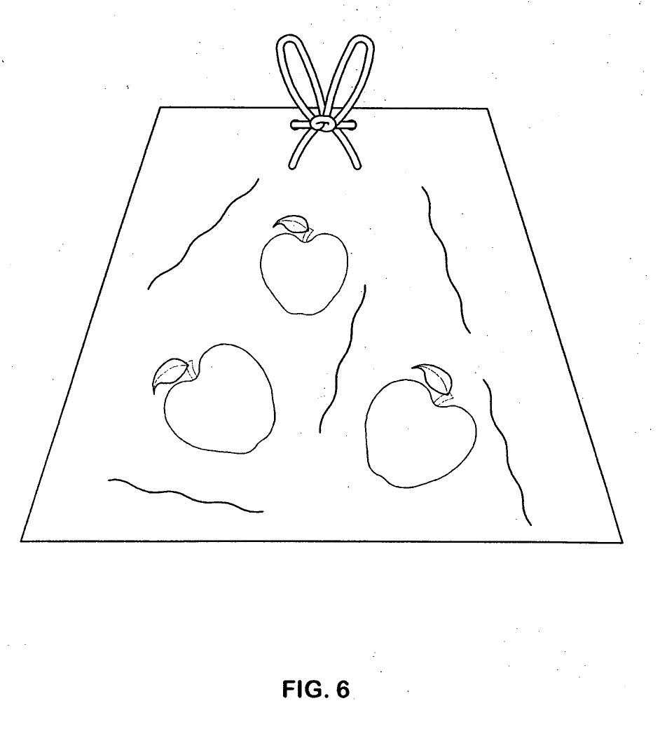

FIG. 6 shows the string through the skirt and how it is decorated in step 6

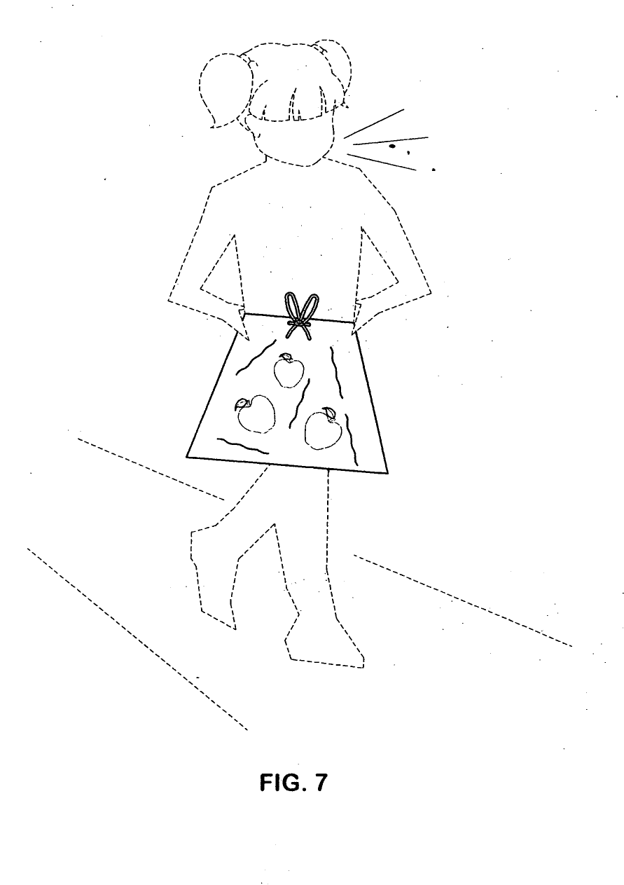

FIG. 7 show the finished skirt on the runway in step 7

Desiner will have packet of materials.

Item 3. Newspaper pattern (cut to fit designer)

Item 4. Approx. 1¼ yard of fabric

Item 2. Scissors

Item 8. Cloth glue

Item 9. Shoe string or ribbon (length of waist)

Item 10. Applicades , sequins, and other

Before party proceedings announce:

“Today we're going to have a designer's party. We will design a skirt, model the skirt, and walk the runway with our skirt. Prizes will be given to the designer who is selected with the best designed skirt, and explanation why the skirt modeled should be chosen for the prize as the model walks the runway.”

Each girl is given a piece of newspaper, fabric, glue and other materials to decorate the skirt. The girl will be given a step-by-step instructions on how to cut and glue the skirt (a monitor walks around to make sure each girl understands the directions). After the skirt is glued, the girls may want to draw and cut applicades, lace, make designs with sequins and etc. as the skirt dries. The girls come back to the glued skirts and decorate them. When the designs are ready, each girl presents her skirt by walking down the runway saying a made up script by the designer and model of the skirt. As they walk they could say for example: “This is a Nancy Smith design. It was created by Nancy Smith. Notice how perfect it would be to be seen by your friends at the mall.”

The model will continue to explain her design to try to get voters to vote her design for the prize. (Could maybe have a one line prescript verse for younger designers and have precut fabric). Ex: “You could be the envy of your friends. Notice the color and the fall of the skirt. The color just brightens the day and makes you feel good.”

Step 1

All designers will cut one basic newspaper pattern (item 3)(FIG. 1). This will be the front and back of the skirt. The designer will use a piece of newspaper folded in the center. The folded newspaper is placed on a girl's center front. Then a pattern is made by slimming the waist of the newspaper (FIG. 1) (monitor or partner help may be needed here). Two designers may work together to help. This step is important because it will make the designer feel a greater part of the process design. Newspaper should be slimmed at the waist a little so as not too much bulk at the waist of the finished product. (FIG. 1)

Step 2

The designer will use skirt newspaper pattern folded in the center. The center of the folded newspaper pattern is placed on the fold of the fabric that is to be used to make the front of the skirt (item 4) (FIG. 2) The designer will cut the fabric around the skirt pattern. Once the fabric is cut, it will be marked skirt front with an erasable pencil. Place the folded news paper again on the fold of the fabric and cut back of the skirt. Mark the fabric skirt back with erasable pencil.

Step 3

Lay the front outside view of the skirt (item 5) marked skirt front on a table or flat surface. Lay the back outside view next to the front outside view. With a pencil mark the fabric front outside view with two dots. One dot is on each side of the fold. Place the dots about 1 inch away from the fold and 3 inches from the top of the skirt. Mark A on the top right front outside view, and mark B on the top left front outside view of the skirt fabric. Then go to right back outside view of skirt (item 6) and mark B and left back outside view of skirt and mark A.

Step 4

Put glue down (item 8) front skirt (item 5) on right side A leaving the 2″ top without glue for waist to come down. Then put glue down (item 8) front skirt (item 5) on left side B leaving a 2″ top without glue to bring down for waist. Then take back skirt (item 6) and place right side B on top of glued B front skirt. Then place back skirt A and place on top of glued front skirt A. Press the glued sides together all the way down on both sides to make sure every part of the sides are glued down. Next trim the edges even on both sides of skirt (item 7).

Let glue set for about 30 minutes to an hour. While glue is setting , designers can select ribbon, beads, applicades, or make designer applications to decorate skirt (FIG. 4).

Step 5

Come back to skirt when dried and bring bottom of skirt up to length desired and flattened with side edges facing back. Flatten the desired hem to back and front of skirt and stretch out. This should give the desired even hem effect. Glue hem to inside of skirt (FIG. 5).

Step 6

Make holes at waist where the dots appear. To form finished waist, put glue on to the top end of the skirt fabric and glue down. The two holes should be in front mid center. Sides should be left unglued for easier shoe lace or ribbon pull.

Step 7

Using a paper clip, stick through ribbon or shoe lace (item 9) and pass ribbon or shoe lace through holes to form fitted waist (FIG. 6). Fold in edges of sides so that the gathered waist does not show edges.

Step 8

Designers decorate their skirts with beads, ribbons, applicades (item 10) and etc. (FIG. 6)

Step 9

The designers now show off their designs and can be judged. Girls can line up taking turns to walk a runway. As they walk, they can say the name of their design. Ex: “This is a Nancy Smith design. It was created by Nancy smith. Wear this fashion and be the envy of all your friends at the mall or party. Notice how the color and the skirt can brighten your day and make you feel good.” (FIG. 7)

I claim this invention as my invention.

1. It is a fun party kit that relates to young girls. It is a kit for designing a skirt. Each girl is provided with a party kit. The kit has a piece of newspaper (item 3), material (item 4), scissors (item 2), glue (item 8) and ribbons and applicades (item 10) to decorate the skirt.
A skirt pattern is cut from the newspaper piece to be used as front and back skirt (FIG. 1)(item 3).
The newspaper pattern is placed on the fabric (FIG. 2) (item 4). The skirt right front is marked A and the left front is marked B (FIG. 3). The newspaper pattern is placed back on the fabric to cut out back skirt. (FIG. 2) (item 4). The back front view of the skirt is marked B on the right and A on the left front (FIG. 3) to show where to put the glue and the material together (FIG. 4)(item 8). The hem for the top of the skirt to form the waist is brought down and glued (FIG. 5)(item 8). The bottom of the skirt is brought up and glued (FIG. 5)(item 8). Two holes are put in the front folded glued waist hem (FIG. 5) (item 8). This is to put a drawstring through and bring in a waist. The skirt is then decorated by the designer. (FIG. 6)
The designer skirt can provide an educational experience in creativity for children. It would be appropriate to teach propaganda in an English class. Once the skirt is designed and finished, the girl becomes a model and sell her skirt. She writes a script, or a script can be provided as she walks down a pretend runway. (FIG. 7)
